(19) United States
(12) Patent Application Publication
(10) Pub. No.: US 2005/0281216 A1
(43) Pub. Date: Dec. 22, 2005

(54) Method for controlling data communication using a network node group in a communication system

(75) Inventors: Tomi Varonen, Helsinki (FI); Miikka Huomo, Vantaa (FI); Tuomas Niemela, Helsinki (FI); Petri Sved, Kerava (FI); Jari Hyytiainen, Helsinki (FI); Tommi Hyrsyla, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/920,362

(22) Filed: Aug. 18, 2004

(30) Foreign Application Priority Data
Jun. 17, 2004 (FI) 20040841

(51) Int. Cl. H04L 12/28; H04Q 7/00

(52) U.S. Cl. 370/328; 370/254

(57) ABSTRACT

The invention relates to a method, a system, a network node and a computer program for controlling data communication in a communication system. In the method a group comprising at least two serving nodes is formed in the communication network. At least one terminal node is associated with the group. Configuration information is received in a first serving node from a second serving node. A first message is received from a terminal node in the first serving node. In the first serving node is determined a second serving node from the group with at least a first identifier in the first message and the configuration information. The first message is sent from the first serving node to the second serving node. The first message is processed in the second serving node. A second identifier indicating the second serving node is provided to the terminal node. The second serving node is indicated in a second message from the terminal node.

### BACKGROUND OF THE INVENTION

1. Field of the Invention

The invention relates to the controlling of data communication in a communication system. Particularly, the invention relates to the forming of network node groups for the processing of data communication traffic.

2. Description of the Related Art

System dimensioning is an important factor in building communication networks. Usually, a basic guideline is to estimate the number of subscribers in different areas in the network. However, it is very difficult to predict traffic distribution in different unusual situations. The situation is particularly difficult in mobile communication networks where mobile subscribers may roam freely in the area serviced by the network. There must be sufficient extra capacity in a network to be able to deal with sudden surges in traffic, otherwise the network may be considered unreliable by customers. The naïve solution to deal with traffic surges is to build systematically redundant capacity in all parts of the network. The extra capacity must be available both as data transmission capacity and processing capacity in a variety of network nodes responsible for partaking in the data transmission process. The naïve solution is incapable of dealing with completely upturned traffic distributions, where previously low-traffic network segments become the most active segments in the network. Such situations occur, for example, in mobile communication networks when large number subscribers decide to roam to a given area in the network. This may occur, for example, in association with sports events. Naturally, in a cellular radio system the number of radio transceivers made available in a cell limits the amount of simultaneous traffic that can be handled in the cell area. Similarly, the density of base transceiver stations imposes a limit on the amount of traffic. However, the number of network elements in the core network and their respective capacities imposes also a limit on the amount of traffic that can be processed pertaining to a given geographic area. In prior art General Packet Radio Service (GPRS) there is a fixed allocation of network elements for geographic areas. The GPRS system is specified in 3G Partnership Project (3GPP) specification 23.060.

Reference is now made to FIG. 1, which illustrates a prior art GPRS architecture. In FIG. 1 there is illustrated an IP network 196, which may be the Internet or a corporate intranet, and the network elements associated with a GPRS network 199. FIG. 1 illustrates the elements associated with a single Serving GPRS Support Node (SGSN), namely SGSN 100. It should be noted that there may also be other SGSNs in GPRS network 199, but they are not considered relevant herein for the purposes of the description of prior art. SGSN 100 is connected to IP network 196 using Gateway GPRS Support Nodes 190 and 192. The subscriber data associated with mobile subscribers is stored in Home Location Register 194, which is enquired by the SGSN 100, for example, during network attach and PDP context activation procedures.

In FIG. 1 there is also a mobile station 198. Mobile station 198 may camp on any of cells made available by GPRS network 199. The cells are arranged into routing areas 140, 150, 160, 170 and 180. Routing area 140 comprises cells 142-146. Routing area 150 comprises cells 152-159. Similarly, there is at least one cell associated with routing areas 160, 170 and 180, but they are not shown. Each cell is served by a Base Transceiver Station (BTS). The base transceiver stations are not shown. There are Base Station Controllers (BSC) 110, 120 and 130. BSC 110 manages the cells associated with routing areas 140 and 150. Packet Control Units (PCU) 112 and 114 processes the packet traffic to and from the cells comprised in routing areas 140 and 150, respectively. The packet control units 112 and 114 have Network Service Virtual Connections 113 and 115 (NS-VC) to SGSN 100, respectively. In SGSN 100 NS-VCs 113 and 115 are handled using a Packet Processing Unit (PAPU) 102. Packet processing unit 102 is located in SGSN 100. SGSN 100 also comprises two other PAPUs, namely PAPU 104 and PAPU 106. PAPU 104 has an NS-VCs to PCU 122. PAPU 106 has NS-VCs to PCU 132 and PCU 134. It should be noted, however, that the internals of SGSN 100 are not within the scope of 3GPP standards, but are, instead, a manufacturer specific solution. In other solutions, in an SGSN there may be, for example, only a single unit, which handles the NS-VCs.

On each NS-VCs is carried a Base Station System GPRS Virtual Connection (BVC) to each Point-To-Point (PTP), Point-To-Multipoint (PTM) and Signaling (SIG) functional entity in the area associated with the PCU in question. Usually, there are a number of PTP BVCs, each one related to a cell. A PTP functional entity is in charge of the user plane related traffic within a given cell. A NS-VC terminates to a Network Service Entity (NSE). The NSE may be, for example, located in a PCU. The Base Station System GPRS Protocol (BSSGP) is specified in the 3GPP specification 48.018. The GPRS network service protocol layer between an SGSN and the Base Station Subsystem (BSS) is specified in 3GPP specification 48.016.

A problem associated with a GPRS network architecture as illustrated in FIG. 1 is that the capacity of a PAPU imposes an upper limit on the amount of traffic that can be processed pertaining to the routing areas connected to it via the PCUs. For example, the capacity of PAPU 102 imposes an upper limit as to the traffic that can be processed to and from routing areas 140 and 150 that are connected to it via PCUs 112 and 114, respectively. Therefore, in order to be able to avoid traffic bottlenecks in PAPUs even in exceptional conditions such as associated with mass meeting, the capacity of a PAPU must be made much higher than what would be justified in normal traffic conditions. This solution introduces additional costs in the form of extra hardware investments. While there is capacity surplus in a PAPU unit serving a given area of the network, there may simultaneously exist capacity shortage elsewhere in the network. Naturally, a similar problem arises in other equivalent system architectures where a serving network node such as an SGSN does not comprise multiple separate processing units, but instead a single processing unit. It is equally possible that the single processing unit becomes a bottleneck in the system. Therefore, an optimal solution has the capability to allocate packet data processing capacity dynamically for different areas in the network. One solution to alleviate the problem is to introduce network entity clusters from which network entities may be allocated for traffic pertaining to a variety of segments or areas in the network. Such a solution applying network entity clusters has been specified in 3GPP specification 23.236 “Intra Domain Connection of RAN Nodes to Multiple CN Nodes”.

Reference is now made to FIG. 2, which illustrates a prior art GPRS architecture applying the solution introduced in 3GPP specification 23.236. The solution is referred to as the multipoint Gb-interface feature. By the Gb-interface is meant the interface between SGSNs and the Base Station Subsystem (BSS). In FIG. 2 there is illustrated an IP network 196, which is connected to a GPRS network via a GGSN 240. Connected to GGSN 240 there are four SGSNs, namely SGSNs 210-216. SGSNs 210 and 212 are grouped in a first cluster 200 while SGSNs 214 and 216 are grouped in a second cluster 202. According to 3GPP specification 23.236, a pool area is an area within which a mobile station may roam without need to change the serving Core Network (CN) node. A pool area is served by one or more CN nodes in parallel. All the cells controlled by a Radio Network Controller (RNC) or BSC belong to the same one (or more) pool area(s). A group of CN nodes serving a pool area is also referred to as an MSC pool or an SGSN pool, respectively. An MSC pool thus comprises at least two MSCs and an SGSN pool at least two SGSNs.

A cluster, in other words an MSC pool or an SGSN pool, thus handles a pool area. In FIG. 2 by way of illustration there are two routing areas 230 and 232, which form two distinct pool areas. Routing area 230 is handled by BSC 220 and routing area 232 by BSC 222. For traffic originating or terminating in the pool area formed by routing area 230, the SGSNs belonging to cluster 200 are considered equal alternatives. Whenever a mobile station within a cell associated with routing area 230 performs a network attach either SGSN 210 or SGSN 212 is considered a candidate for processing the packet data traffic pertaining to the mobile station. When an initial network attach request message is received at BSC 220 from a given mobile station 234, it performs a Non-Access Stratum (NAS) node selection function to determine whether SGSN 210 or SGSN 212 should be assigned for mobile station 234. In FIG. 2 an attach request message originating from mobile station 234 is illustrated with arrow 250. The NAS node selection function has been configured with information regarding, which SGSNs form the cluster for the pool area associated with routing area 230. Similarly, clusters may be formed of MSCs for the processing of circuit switched calls associated with a given pool area.

By an initial attach request is herein meant an attach request, which reveals that no SGSN has yet been assigned for mobile station 234. Attach request messages and routing area update messages comprise a Temporary Logical Link Identifier field. Part of the field comprises a Network Resource Identifier (NRI). The NRI is used by a GPRS network elements, for example, by BSCs to determine, which SGSN has been assigned for the mobile station that sent the message. An attach request wherein a Temporary Logical Link Identifier field has a random value is an initial attach request. Let us assume that NAS node selection function in BSC 220 assigns SGSN 210 for mobile station 234. Thereafter, BSC 220 forwards the attach request message to SGSN 210. When SGSN 210 prepares a response message to the attach request, it allocates a Packet Temporary Mobile Station Identity (P-TMSI) and sets a set of bits comprised therein to a value, which corresponds to the NRI value reserved for the SGSN 210. The NRI values are unique within a single pool area. A new TLLI is determined from the P-TMSI so that the new TLLI will comprise also the NRI value. The mobile station 234 obtains the new TLLI. The new TLLI is used by mobile station 234 in subsequent routing area update and attach request messages sent to BSC 220. By inspecting the TLLI BSC 220 is able to extract the TLLI value and forward the message received to the SGSN that is indicated by the NRI value, which in this case is SGSN 210. In case mobile station 234 performs an inter SGSN routing area update, the TLLI value is also sent to the new SGSN, which by using the NRI value therein is able to determine the old SGSN, from which information pertaining to mobile station 234 may be retrieved.

A problem associated with a solution such as described in FIG. 2 is that the NRI to SGSN and NRI to MSC mappings and network element assignment introduce new functionalities in the SGSNs, the MSCs and the BSCs. The maintaining of the mappings requires considerable care as new network elements are introduced to the clusters. Another problem associated with a solution such as described in FIG. 2 is that network node clusters, for example, SGSN or MSC clusters associated with a given pool area, are not just visible in the core network stratum, but instead they are visible to neighboring network elements, for example, in the access stratum. In other words, the BSCs must be configured with information pertaining to, for example, the SGSN clusters and the mappings between NRIs and SGSN addresses. The introduction of network element clusters in one system layer makes the network element clusters visible to the neighboring system layers, which complicates the overall system architecture. An optimal solution would make the network element clusters hidden from the neighboring system layers.

Yet another problem arises as several CN entities such as SGSNs or GGSNs are grouped from BSS point of view in a manner similar to FIG. 1. In order to be able to allocate NRI values for each individual CN entity the NRI field must be made sufficiently long. This may cause that the TLLI space runs out. A further problem arises when applying the multipoint Gb-interface feature is that each CN entity must store information on all the cells contained in the pool area.

### SUMMARY OF THE INVENTION

The invention relates to a method for controlling data communication in a communication network comprising at least two serving nodes. In the method a group comprising at least two serving nodes is formed in the communication network; at least one terminal node is associated with the group; configuration information is received in a first serving node from a second serving node; a first message is received from a terminal node in the first serving node; in the first serving node is determined a second serving node from the group with at least a first identifier in the first message and the configuration information; the first message is sent from the first serving node to the second serving node; the first message is processed in the second serving node; an second identifier indicating the second serving node is provided to the terminal node; and the second serving node is indicated in a second message from the terminal node.

The invention relates also to a communication system comprising: at least one terminal node; a serving node group comprising at least a first serving node and a second serving node, wherein said first serving node is configured to receive configuration information from said second serving node, to receive a first message from a terminal node, to select said second serving node from said group with at least a first identifier in said first message and said configuration information, and to send said first message to said second serving node; wherein said second serving node is configured to process said first message and to provide an second identifier indicating said second serving node to said terminal node; and wherein said terminal node is configured to indicate said second serving node in a second message.

The invention relates also to a network-node for serving at least one terminal node comprising: a configuration entity configured to receive configuration information from a second network node, and to provide said configuration information to an inter-face entity; wherein said interface entity is configured to receive a first message from a terminal node, to select said second network node with at least a first identifier in said first message and said configuration information, to send said first message to said second network node, to process said first message, and to provide an second identifier indicating said second serving node to said terminal node.

The invention relates also to a computer program comprising code adapted to perform the following steps when executed on a data-processing system: forming a group comprising at least two serving nodes in a communication network; associating at least one terminal node with the group; receiving configuration information in a first serving node from a second serving node; receiving a first message from a terminal node in the first serving node; determining in the first serving node a second serving node from the group with at least a first identifier in the first message and the configuration information; sending the first message from the first serving node to the second serving node; processing the first message in the second serving node; providing an second identifier indicating the second serving node to the terminal node; and indicating the second serving node in a second message from the terminal node.

In one embodiment of the invention, load information associated with at least one serving node is collected within the group and the load information is checked in the determining, in other words, the selection of the second serving node.

In one embodiment of the invention, the communication network is a mobile network, the terminal node is a mobile node and the network node for serving at least one terminal node is a serving node. In one embodiment of the invention the mobile node is a mobile station.

In one embodiment of the invention, the second serving node determined from the group by the first serving node is allowed to be the first serving node. That is, the first serving node is allowed to determine itself as the second node with at least a first identifier in the first message and the configuration information as criteria. Thereupon, the first message is processed in the first serving node, a second identifier indicating the first serving node is provided to the terminal node and the first serving node is indicated in a second message from the terminal node. However, it should be noted that in this embodiment the first serving node is as well allowed to determine a second serving node different from the first serving node in the determination step.

In one embodiment of the invention, the mobile network is a General Packet Radio System (GPRS) network or a Universal Mobile Communications (UMTS) Network. In one embodiment of the invention, the serving node is a Core Network (CN) entity, for example, a Serving GPRS Support Node (SGSN), a Mobile services Switching Center (MSC), a mobile services switching center server or an IP Multimedia System (IMS) Call State Control Function (CSCF). In one embodiment of the invention, a Core Network (CN) entity is an entire monolithic Serving GPRS Support Node (SGSN). In one embodiment of the invention, the Core Network (CN) entity is a computer unit, which appears to other network nodes as a separate SGSN, within a distributed architecture cluster SGSN node. In one embodiment of the invention, the serving node group is comprised in a core network node. In one embodiment of the invention, the serving node is a computer unit comprised in a core network node. In one embodiment of the invention, the serving node is a computer unit, in other words, a Packet Processing Unit (PAPU) i.e. a packet unit, in a Serving GPRS Support Node (SGSN). In one embodiment of the invention, the serving node is a Serving GPRS Support Node (SGSN) within an SGSN group. In one embodiment of the invention, the configuration information comprises Radio Access Network (RAN) configuration information associated with a RAN connected to the core network. The RAN configuration information comprises information, for example, on connections from different serving nodes to different RAN areas. For example, in the case of a Universal Mobile Telecommunications System (UMTS) core network the information on connections may specify the existence of connections from serving nodes to individual Packet Control Units. For example, in the case of a General Packet Radio System (GPRS) core network the information on connections may specify the existence of connections from serving nodes to individual Network Service Entities (NSE).

In one embodiment of the invention, the first identifier and the second identifier are Temporary Mobile Subscriber Identities (TMSI). In one embodiment of the invention, the first identifier and the second identifier are Temporary Mobile Subscriber Identities (TMSI) used to identify a mobile station to a circuit switched network element. In one embodiment of the invention, the first identifier is a Temporary Logical Link Identity (TLLI) and the second identifier is a Packet Temporary Mobile Subscriber Identity (P-TMSI). The indicating of the second serving node in a second message from the terminal node is performed so that at least part of the second identifier is specified in the second message. In one embodiment of the invention, the computer units are addressed in at least one Gateway GPRS Support Node (GGSN) as separate Serving GPRS Support Nodes (SGSN).

In one embodiment of the invention, the communication network is an IP network. In one embodiment of the invention, the first message is a network attach message. In one embodiment of the invention, the second message is an uplink packet from the terminal node.

In one embodiment of the invention, the communication network comprises at least a Circuit Switched (CS) network and the serving nodes are exchanges, for example Mobile Services Switching Centers (MSC), within the CS network. In one embodiment of the invention, the first message is a registration message, for example, an initial location update request message and the second message is a call set-up request message or a subsequent location update request message.

In one embodiment of the invention, the determining, in other words, the selecting of the second serving node from the group comprises the forming of a candidate serving node list by filtering based on the configuration information the suitable serving nodes from the group, the computation of a hash code from the first identifier, and selecting the second serving node from the candidate serving node list by indexing with the hash code. The hash code is computed, for example, by dividing said first identifier by the number of candidate nodes in the candidate serving node list and taking the remainder. By a suitable serving node is meant herein a serving node that is, for example, in active state, is not overloaded, and has configured and active connections to the current RAN area of the terminal node.

In one embodiment of the invention, the computer program is stored on a computer readable medium. The computer readable medium may be a removable memory card, magnetic disk, optical disk or magnetic tape.

In one embodiment of the invention, the terminal node is a mobile device, for example, a laptop computer, palmtop computer, mobile terminal or a personal digital assistant (PDA). In one embodiment of the invention the terminal node is a desktop computer or any other computing device.

The benefits of the invention are related to the improved performance in a communication system. When CN entities are grouped, it is possible to achieve more capacity for the served radio network or a part of the radio network, for example, a routing area or a location area or generally a RAN area comprising at least one cell. With the invention it is possible to achieve dynamic subscriber capacity control. Further, it is easier to manage grouped CN entities than individual CN entities.

Yet another benefit is in the fact that the grouping of CN entities is hidden from the neighboring network layers or network entities such as the radio network, another type of access network and the gateway nodes such as the GGSNs. It is no longer necessary to configure CN entity group information to neighboring network entities and to perform in them CN entity determination and selection procedures. For example, the invention provides an alternative for the multipoint Gb-interface, the multipoint Iu-interface and the multipoint A-interface.

Yet another benefit in the invention is that by sharing configuration information it is possible to perform efficient and correct CN entity selection in other CN entities within a CN entity group.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a block diagram illustrating a prior art General Packet Radio System (GPRS) network with distributed architecture Serving GPRS Support Nodes (SGSN);

FIG. 2 is a block diagram illustrating a prior art General Packet Radio System (GPRS) network with SGSN clusters in accordance with the multipoint Gb-interface feature;

FIG. 3 is a block diagram illustrating a mobile communication network equipped with a Core Network (CN) entity cluster according to the invention;

FIG. 4A is a block diagram illustrating a Core Network (CN), in which each Radio Access Network (RAN) area is connected to each Core Network (CN) entity in a Core Network (CN) node, according to the invention;

FIG. 4B is a block diagram illustrating a Core Network (CN), in which different cells under a Routing Area (RA) or a Location Area (LA) are handled by different CN entities in a Core Network (CN) node, according to the invention;

FIG. 4C is a block diagram illustrating a Core Network (CN), in which a cell or a Radio Access Network (RAN) area is assigned to a given CN entity in a Core Network (CN) node, according to the invention;

FIG. 4D is a block diagram illustrating a Core Network (CN), in which a cell or a RAN area is assigned to a given Core Network (CN) Entity in a Core Network (CN) node and a Radio Network (RAN) area may have a connection to more than one Core Network (CN) entity, according to the invention;

FIG. 5A is a block diagram illustrating a Core Network (CN) node with an unavailable network connection, according to the invention;

FIG. 5B is a block diagram illustrating Core Network (CN) entity update processing in a Core Network (CN) node, according to the invention;

FIG. 6A is a signaling diagram, which illustrates network attach processing, according to the invention;

FIG. 6B is a signaling diagram, which illustrates Packet Data Protocol (PDP) Context activation, according to the invention;

FIG. 6C is a signaling diagram, which illustrates intra Core Network (CN) entity group Routing Area Update (RAU) processing, according to the invention;

FIG. 6D is a signaling diagram, which illustrates one embodiment of inter CN entity group Routing Area Update (RAU) processing, according to the invention;

FIG. 7 is a flow chart depicting one embodiment of serving node determination method, according to the invention;

FIG. 8 is a flow chart depicting one embodiment of Core Network (CN) entity determination method in a Core Network (CN) node, according to the invention; and

FIG. 9 is a block diagram illustrating software and hardware architecture in a distributed architecture Serving GPRS Support Node (SGSN), according to the invention.

### DETAILED DESCRIPTION OF THE EMBODIMENTS

Reference will now be made in detail to the embodiments of the present invention, examples of which are illustrated in the accompanying drawings.

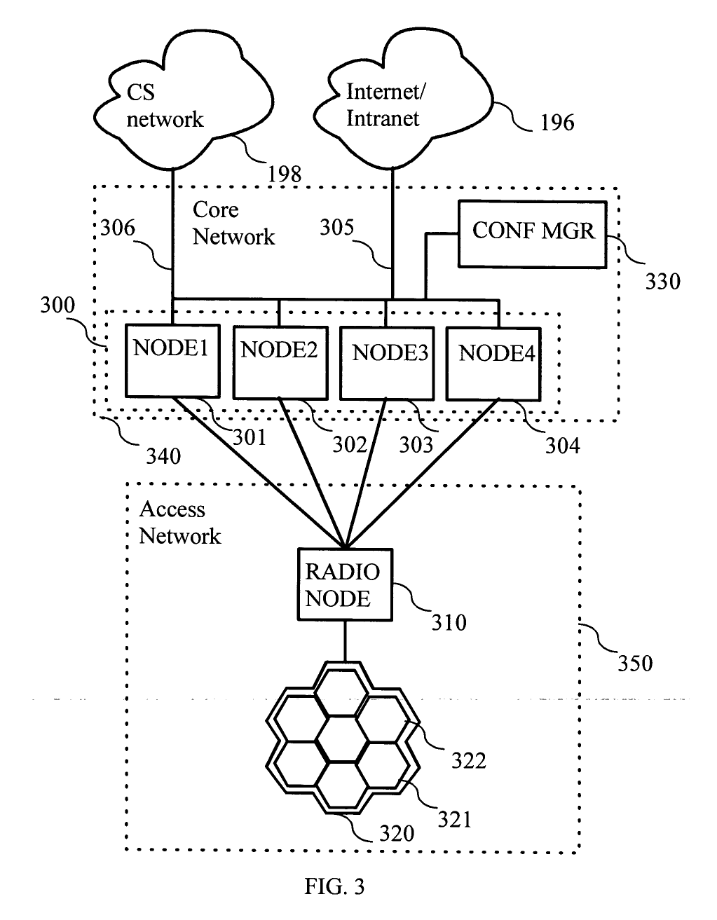

FIG. 3 is a block diagram illustrating a mobile communication network in one embodiment of the invention. The mobile communication network comprises a Core Network (CN) 340. CN 340 may be, for example, a Universal Mobile Telecommunications System (UMTS), a Global System of Mobile communications (GSM) or a General Packet Radio Service (GPRS) core network. A CN comprises a number of CN entities such as, for example, packet data support nodes, call processing nodes, gateway nodes and switching centers. In the case of UMTS, GSM and GPRS, the CN entities comprise, for example, Serving GPRS Support Nodes (SGSN), Gateway GPRS Support Nodes (GGSN), Call State Control Functions (CSCF), Mobile Switching Centers (MSC) and MSC servers. The architecture of a UMTS core network is specified in the 3GPP specification 23.002.

The mobile communication network is connected to an IP network 196, which is, for example, the Internet or an Intranet. The mobile communication network is also connected to a Circuit Switched (CS) network, which is, for example, the Public Switched Telephone Network (PSTN), if access to circuit switched services is offered by the CN. Within the CN voice, video and data services may be circuit switched or packet switched. The mobile communication network may be connected to a number of other networks, but they are not shown. CN 340 is connected to an access network 350, which comprises a radio node 310. Radio node 310 serves a Radio Access Network (RAN) area 320, which comprises, for example, cells 321 and 322. Access network 350 may be, for example, a UMTS Radio Access Network (UTRAN) or a GSM/Edge Radio Access Network (GERAN). Radio node 310 may be, for example, a GERAN Base Station Controller (BSC), a UMTS Radio Network Controller (RNC) or equivalent radio node. Access network 350 may be connected to CN 340 using, for example, the UMTS Iu-PS or Iu-CS interfaces, or the GERAN A-interface or Gb-interface. RAN area 320 may be a Routing Area (RA), a Location Area (LA) or a group comprising a number of routing areas or location areas. A RAN area may also be a smaller area comprising a number of cells. In a RAN area there is at least one cell. In one embodiment of the invention a RAN area is an area, the traffic of which is handled by a given RAN entity, for example, a Packet Control Unit (PCU).

CN comprises a CN entity group 300 and a configuration manager 330. CN entity group 300 comprises CN entities 301-304. CN entities 301-304 may be independent network nodes or units within distributed architecture CN node comprising at least CN entity group 300. A distributed architecture CN node may be, for example, a blade server. A CN entity group may also be called a CN entity cluster. CN entity group 300 may be connected to IP network 196 via a number of gateway nodes (not shown). In FIG. 3 there is a connection from each of the CN entities to radio node 310. When a mobile station (not shown) enters an area controlled by CN entity group 300 it sends a network attach request. As the network attach request or any other service request is received by radio node 310 from the mobile station, it forwards the request to a CN entity within CN entity group 300. The mobile node may be, for example, a mobile station of a cellular radio system. Radio node 310 does not have to be informed as to the number of CN entities in the CN entity group, radio node 310 simply accesses, for example, a predefined CN entity that is connected to it.

Let us assume that radio node 310 sends, for example, a network attach request to CN entity 301. The network attach request carries a random temporary mobile subscriber identity, which has been generated by the mobile station. Thereafter, CN entity 301 assigns one of the CN entities in CN entity group 300 to process the network attach request and all the entailing requests pertaining to the mobile node. The assigned CN entity may also be called an owner CN entity in the sense that it has the responsibility for processing the traffic pertaining to the mobile node. The CN entity assignment procedure is performed so that CN entity 301 computes a hash code from a predetermined identifier carried in the network attach request. The aforementioned computation of the hash code in order to assign a CN entity is performed due to the fact that the mobile station may send more than one network attach request having same random temporary mobile subscriber identity. This occurs, for example, if no acknowledgement is received within a predefined time for the network attach request. It is necessary that same CN entity receives both requests in order to avoid the handling of network attach requests from the same mobile station in different CN entities.

In one embodiment of the invention the hash code is computed by dividing the predetermined identifier by a number N and taking the remainder, wherein the number N represents the number of CN entities in CN entity group 300. The hash code denotes the index for the CN entity that is assigned to process the network attach request. Let us assume that the hash code computed by CN entity 301 denotes the index value 3, which corresponds to the third CN entity, namely CN entity 303 in CN entity group 300. In general, the index values 1, 2, 3 and 4 correspond to CN entities 301, 302, 303 and 304, respectively. Thereupon, CN entity 301 forwards the network attach request to CN entity 303, which processes the network attach request and gets prepared for processing the subsequent traffic from the mobile node. In one embodiment of the invention, the CN entity informs to the mobile node a new Temporary Mobile Subscriber Identity (TMSI) or another equivalent identifier, which is used by the mobile node in subsequent requests to identify that CN entity 303 has been assigned for the mobile node. The new TMSI comprises the index value for the assigned CN entity. A TMSI comprising a CN entity index must also comprise other information, which reveals to a receiving CN entity that a CN entity is carried in the TMSI. This information is specified, for example, so that the TMSI is selected from a specific TMSI numbering space.

Uplink traffic may be forwarded similarly by CN entity 301 to CN entity 303. The forwarding of the uplink traffic is performed based on the TMSI, which specifies the CN entity index. The mobile station uses the TMSI in messages carrying packet data or call set-up requests. For downlink packets originating from a gateway node, the owner CN entity may be determined in a number of ways. In one embodiment of the invention, the CN entities in CN entity group 300 may appear to the gateway node as separate nodes. In one embodiment of the invention, the gateway node sees CN entity group 300 as a single node. In this case there is a front-end node (not shown) connected to CN entities 301-304 and the gateway node, which is responsible for receiving downlink packets from gateway node and forwarding the downlink packets to the correct owner CN entity. The owner CN entity determination may be performed using a memory accessed by the front-end node, which comprises mapping information for mapping packet destination addresses to owner CN entity indexes. In yet another embodiment of the invention, the gateway node sends each downlink packet to each serving CN entity in CN entity group 300.

Configuration manager 330 is provided with configuration information updates from CN entity 301-304. Always when there is a change in the configuration information pertaining to one of the CN entities, the CN entity in question forwards the changed configuration information to configuration manager 330, which takes care of distributing the changed information to other CN entity in CN entity group 300. For example, when a new connection is configured between a radio node and a CN entity, the availability of the new connection is announced from the CN entity to the configuration manager. In one embodiment of the invention the configuration manager is not a separate node, but hosted in one of the CN entities in the CN entity group. In one embodiment of the invention there is no configuration manager, but instead the configuration information updates are distributed from the CN entity that received the update to other CN entities within the CN entity group. The distribution may be implemented, for example, using IP multicast so that the CN entities 301-304 belong to a multicast group. In yet another embodiment of the invention, a hybrid mechanism is applied wherein there is a configuration manager, but time critical messages pertaining to, for example, flow control are distributed in the CN entity group using IP multicast.

In one embodiment of the invention, CN entity groups are applied in mobile communication networks in the circuit switched side of the core network. In this embodiment, a CN entity is a Mobile Switching Center (MSC) and CN entity groups are MSC clusters.

In one embodiment of the invention, CN entity groups are applied in a fixed IP network. In this embodiment, instead of a radio node, the CN entities are connected to access nodes (not shown), from which there are connections to a number of fixed IP terminals. In this embodiment the network attach requests are, for example, link layer connection establishments. In other aspects the CN entity assignment, the request forwarding, the packet data traffic processing and the configuration updating procedures may be similar to the case where the invention is applied in a mobile communication network.

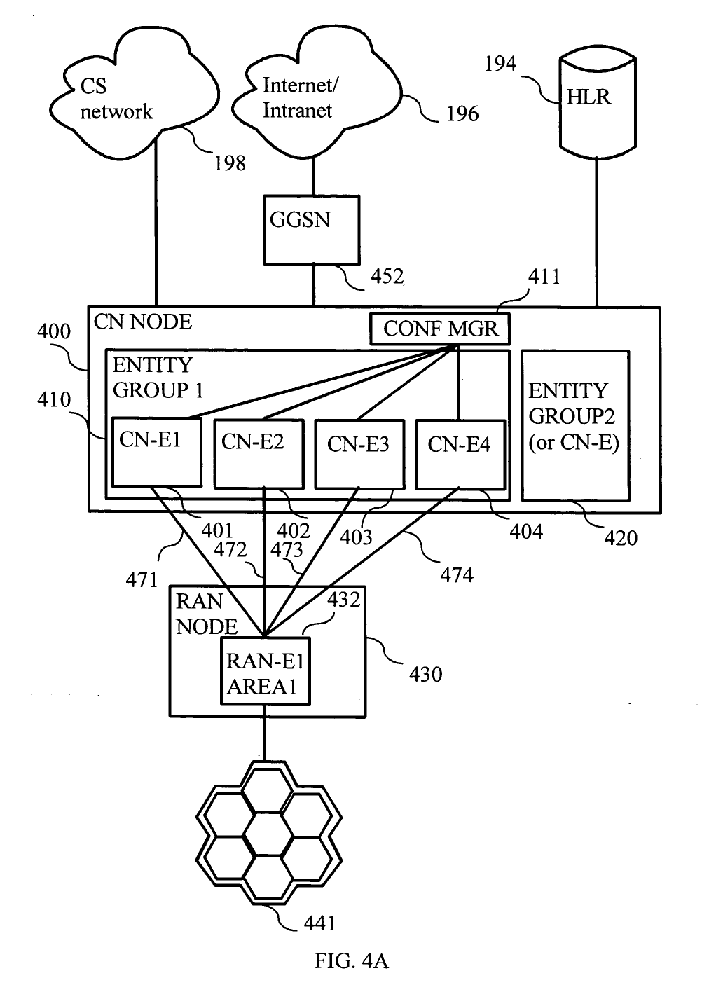

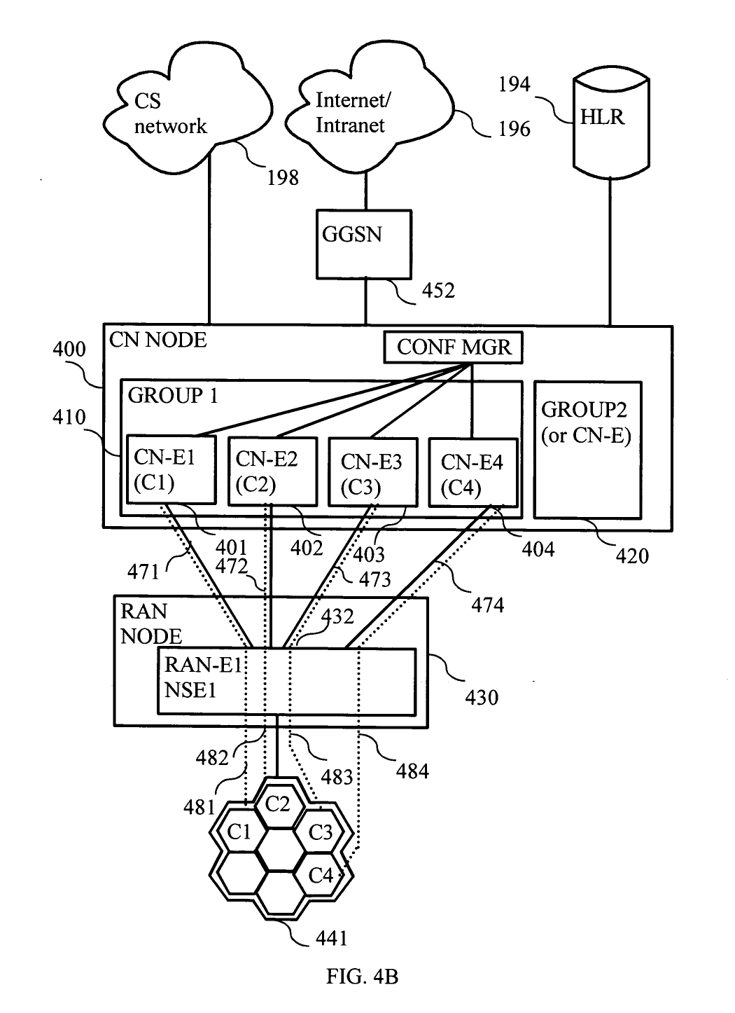

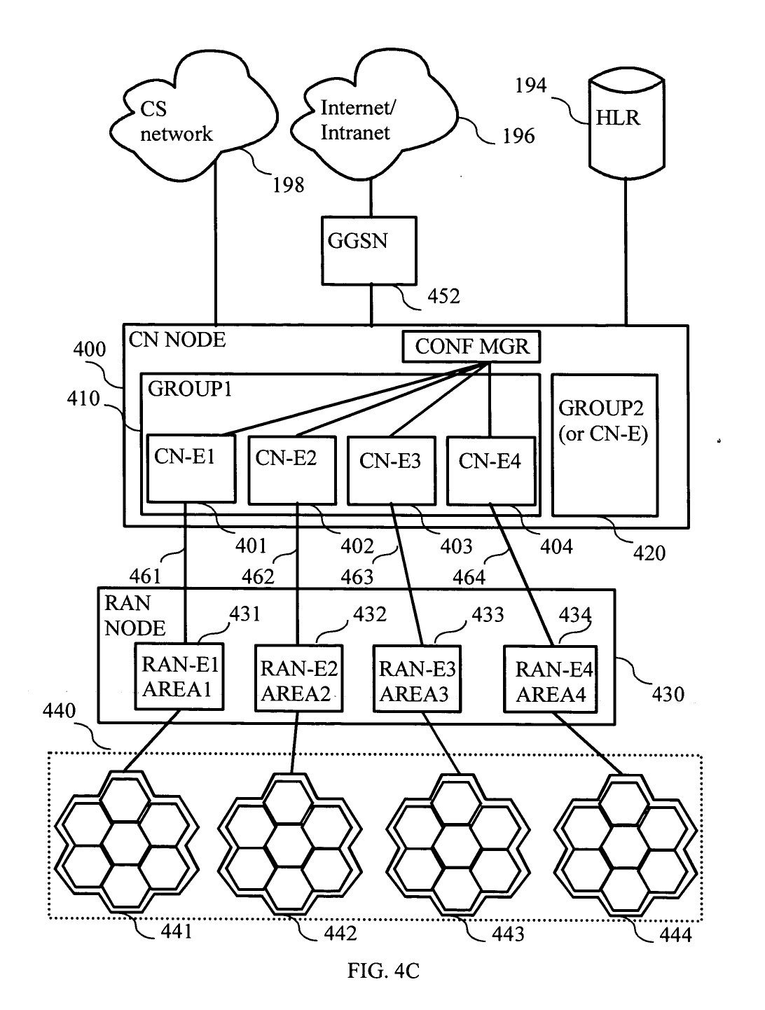

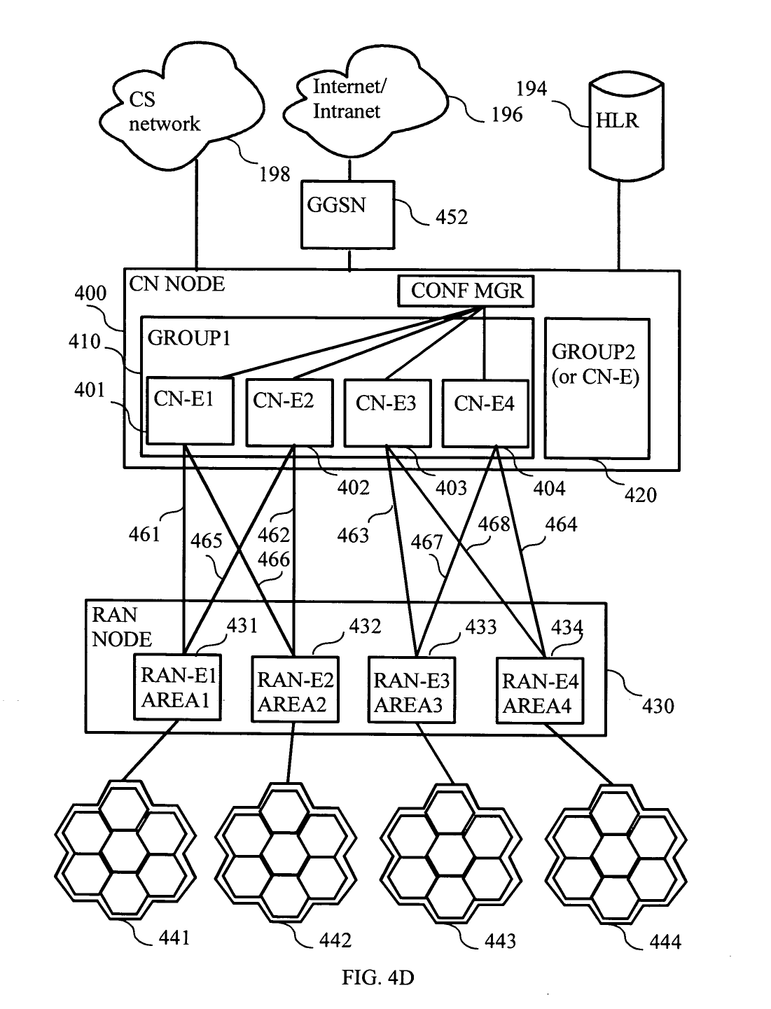

FIG. 4A is a block diagram illustrating a Core Network (CN) in one embodiment of the invention, in which each Radio Access Network (RAN) area is connected to each CN entity in a CN Node. The CN in FIG. 4 is connected to an IP network 196, which is, for example, the Internet or an Intranet, and a Circuit Switched (CS) network, which is, for example, the PSTN. The CN may also be connected to any number of external IP networks via different access points. The CN comprises also a Gateway GPRS Support Node (GGSN) 452. The CN also comprises a distributed architecture CN node, which further comprises CN entity groups 410 and 420. CN entity group 410 comprises CN entities 401-404. There is at least one CN entity (not shown) in CN entity group 420 as well. There is also a configuration manager 411, to which CN entities 401-404 post configuration update information and from which configuration update information is distributed to CN entities 401-404. In one embodiment of the invention, the configuration manager is specific to a CN entity group. In another embodiment of the invention, the configuration manager is shared by a number of CN entity groups in CN node 400. CN node 400 is connected to a Home Location Register (HLR) 194, which stores subscriber information pertaining to the mobile subscribers. There is an RA/LA 441, which is served by a RAN node 430. RA/LA 441 may be a Routing Area (RA) or a Location Area (LA). In RAN node 430 there is a RAN entity 432, which acts as a connection termination entity for cells within a RAN area in its responsibility. RAN entity 432 is responsible for controlling a number of cells in RA/LA 441 or all cells in RA/LA 441. In FIG. 4A the set of cells controlled by RAN entity 432 is the set of cells in RA/LA 441. However, it is equally possible that RAN entity 432 would only control a subset of the cells within RA/LA 441 and there would be a number of other RAN entities controlling the rest of the cells in RA/LA 441.

There are connections 471-474 from CN entities 401-404 to RAN entity 432, respectively. In the embodiment illustrated in FIG. 4A, there is a connection from RAN entity 432 to all CN entities within CN entity group 410. Further, in this embodiment of the invention, the cells, routing areas, location areas and RAN areas within a CN entity group are shared. This means that the traffic from any of the cells, routings areas, location area or RAN areas within the control of a given CN entity group may be assigned to any of the CN entities in that group. When a network attach request is received via one of the connections 471-474, the receiving CN entity may assign any of the CN entities for the mobile station that sent the request. In one embodiment of the invention, the receiving CN entity may also check the status of the connections to the RAN entity 432 from the other CN entities in CN entity group 410. Thereupon, the receiving CN entity forwards the request to the assigned CN entity. For example, when CN entity 401 receives a network attach request via connection 471 from RAN entity 432 originating from a mobile station (not shown), CN entity 401 determines the serving CN entity for the mobile station.

The embodiment as illustrated in FIG. 4A is safe and reliable if the RAN nodes, for example BSCs, use default values for BVC flow control, because the mobile station flow control prevents overloading in the buffers of the BSCs. BVC flow control capacity adjustment is allowed in this embodiment due to the fact that cells are shared. The benefit of this embodiment in relation to prior art is that it increases subscriber capacity in a routing area in proportion to the number of CN entities in the CN entity group associated with the routing area. Maximum data throughput capacity is increased when a connection from a given RAN entity is connected to all CN entities in the CN entity group in charge of the cells associated with the RAN entity.

FIG. 4B is a block diagram illustrating a Core Network (CN) in one embodiment of the invention, in which different cells under a Routing Area (RA) or Location Area (LA) are handled by different CN enties in a CN node. In FIG. 4B there are connections 471-474 from CN entities 401-404 to RAN entity 432, respectively. Thus, there is a connection from a RAN entity 432 to all CN entities within a CN entity group 410. However, the cells within a given routing area or location area are divided among the CN entities in a CN entity group. For example, CN entities 401-404 are assigned for cells C1-C4, respectively. In FIG. 4B RAN entity 432 terminates connections 471-474. On connections 471-474 are carried higher layer connections (not shown), which carry in one embodiment of the invention full-duplex packet streams 481-484 to and from cells C1-C4, respectively. In one embodiment of the invention, the higher layer connections terminate at RAN entity 432 in PTP functional entities (not shown). There is one PTP functional entity for each cell. The PTP functional entities transmit and receive the packet streams further to and from the BTSes (not shown) for cells C1-C4. For example, the packet stream 481 carries packet traffic to and from cell C1. The dividing of cells between different CN entities entails that when a given mobile station (not shown) moves from a first original cell to a second cell, all downlink packet data for that mobile station must be directed via the CN entity serving the first cell to RAN entity 432 within a RAN node 430. In this embodiment, the CN entity group handles the BVC flow control and network operators do not need to control it with parameters. In this embodiment CN entities do not have to store information on all cells. This embodiment is beneficial in situations where the RAN node may have only one RAN entity area per an RA or an LA. This limitation is due to RAN node manufacturer design choices and may not be altered by network operators. This embodiment increases subscriber capacity and provides increased throughput capacity compared to prior art.

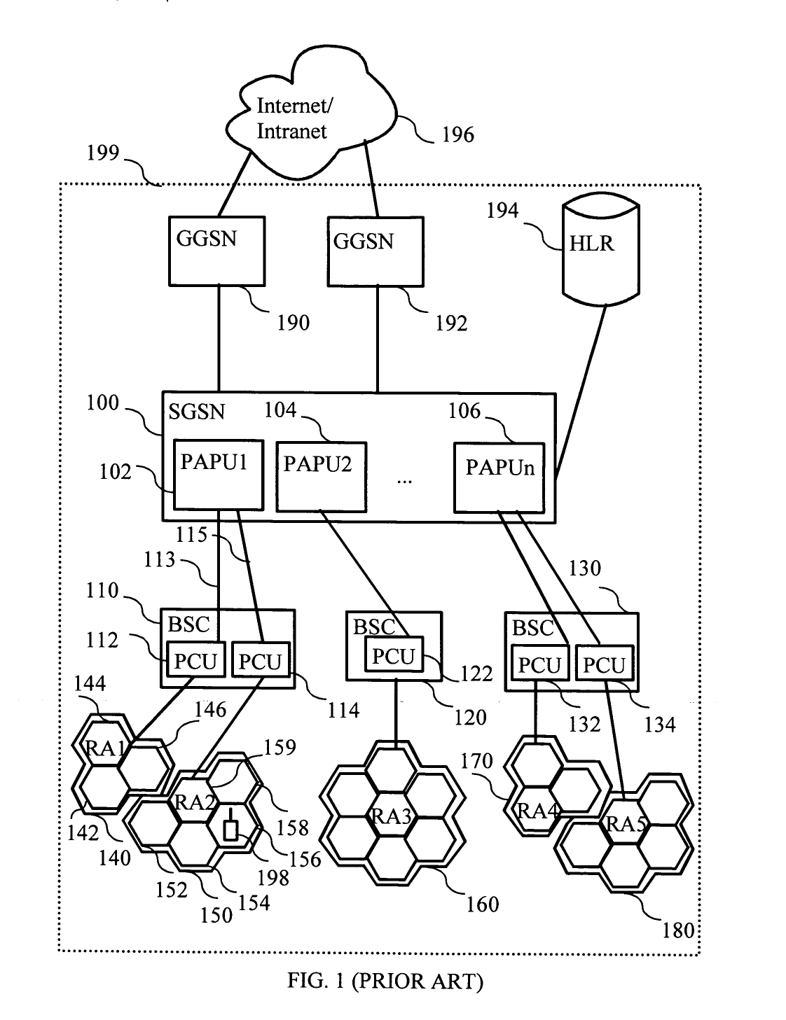

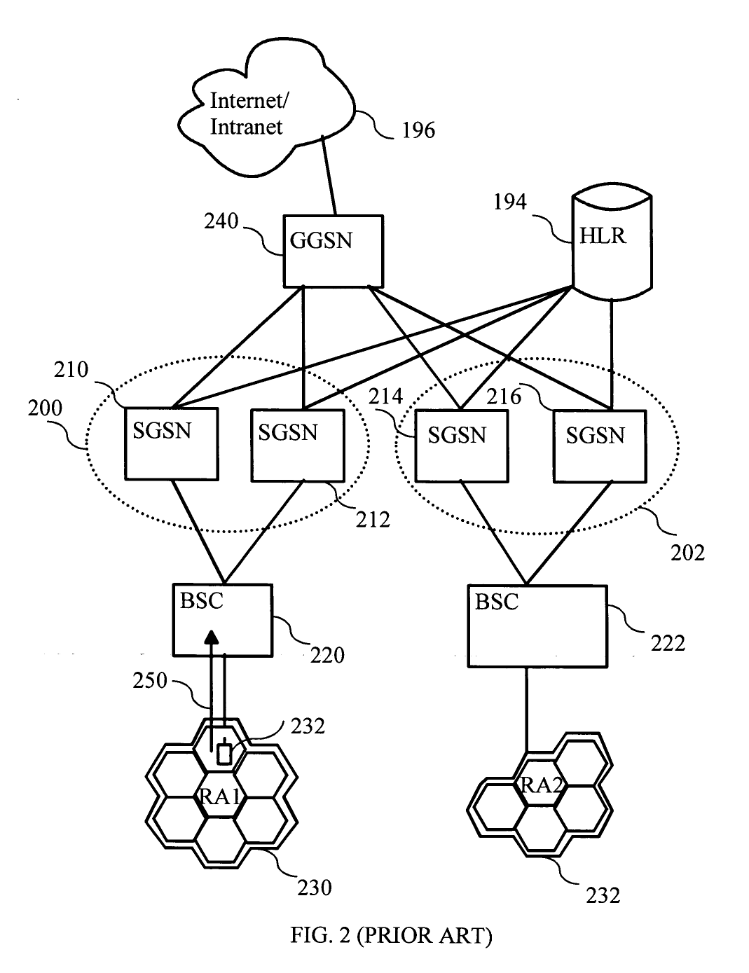

FIG. 4C is a block diagram illustrating a Core Network (CN) in one embodiment of the invention, in which a cell or a RAN area is assigned to a given CN entity in a CN node. In FIG. 4C there are RAN entities 431-434, which are connected to CN entities 401-404 using connections 461-464, respectively. RAN entities 431-434 represent RAN areas for connections 461-464. There are four RAN areas, namely RAN areas 441-444, each of which comprises at least one cell. RAN areas 441-444 belong to a single RA/LA, which is an RA/LA 440. RA/LA 440 is shared between CN entities in a manner similar to the embodiments of the invention illustrated in FIGS. 4A and 4B. In the embodiment illustrated in FIG. 4C, one cell or RAN area is assigned to a given CN entity. For example, RAN area 441 is assigned to CN entity 401. The embodiment illustrated in FIG. 4C requires that a routing area must be handled by a number of RAN entities. In this embodiment of the invention, downlink packets must be forwarded from a first CN entity to a second CN entity in case a mobile station moves from the RAN area associated with the first CN entity to the RAN area associated with the second CN entity. This embodiment may be used in RAN nodes that support several RAN areas per one RA. Compared to the prior art model illustrated in FIG. 1, the subscriber capacity in a routing area is increased in proportion to the number of CN entities in a CN entity group serving RAN areas from that routing area. Gb-interface re-configuration is not required to increase CN entity capacity, if data capacity between a RAN node and the CN node hosting the CN entity group is adequate for the increased number of subscribers.

FIG. 4D is a block diagram illustrating a Core Network (CN) in one embodiment of the invention, in which a cell or a RAN area is assigned to a given CN entity in a CN node and a RAN entity may have a connection to more than one CN entity. The model presented in FIG. 4D is a hybrid of the models presented in FIGS. 4B and 4C. A CN entity 401 is connected to RAN entities 431 and 432 using connections 461 and 466, respectively. A CN entity 402 is connected to RAN entities 431 and 432 using connections 465 and 462, respectively. A CN entity 403 is connected to RAN entities 433 and 434 using connections 463 and 468, respectively. A CN entity 404 is connected to RAN entities 433 and 434 using connections 467 and 464, respectively. The model illustrated in FIG. 4D allows an operator to distribute cells or RAN areas to different CN entities in a CN entity group and to assign given cells or RAN areas to given CN entities.

In one embodiment of the invention, the CN entities discussed in association with FIGS. 4A-4D are Packet Processing Units (PAPU) in an SGSN, the connections are Network Service Virtual Circuits (NS-VC) or ATM virtual circuits, the RAN entities are Packet Control Units (PCU) within a BSC or an RNC and a RAN area is the set of cells accessed via a given PCU.

In one embodiment of the invention, the receiving CN entity for an initial message originating from a mobile station (not shown) may also check the existence of connections in other CN entities in the CN entity group 410 to the RAN entity or RAN area in the area of which the mobile station is currently located. The existence of connections is provided in the configuration information obtained to the receiving CN entity from other CN entities in CN entity group 410. The receiving CN entity determines, in other words, selects a serving CN entity with the configuration information at least concerning the existence and status of connections to the current RAN entity or RAN area for mobile station and a hash code computed from a TMSI sent by the mobile station. Thereupon, the receiving CN entity forwards the initial message for further processing to the serving CN entity. It should be noted that the checking of CN entity configuration information as to the availability of connections from the CN entity to the area in which the mobile station is currently located is applicable in any of the models disclosed in association with FIGS. 4A-4D. Serving CN entity selection may be affected provided that connections from at least two CN entities to the current mobile station area exist and are in active state.

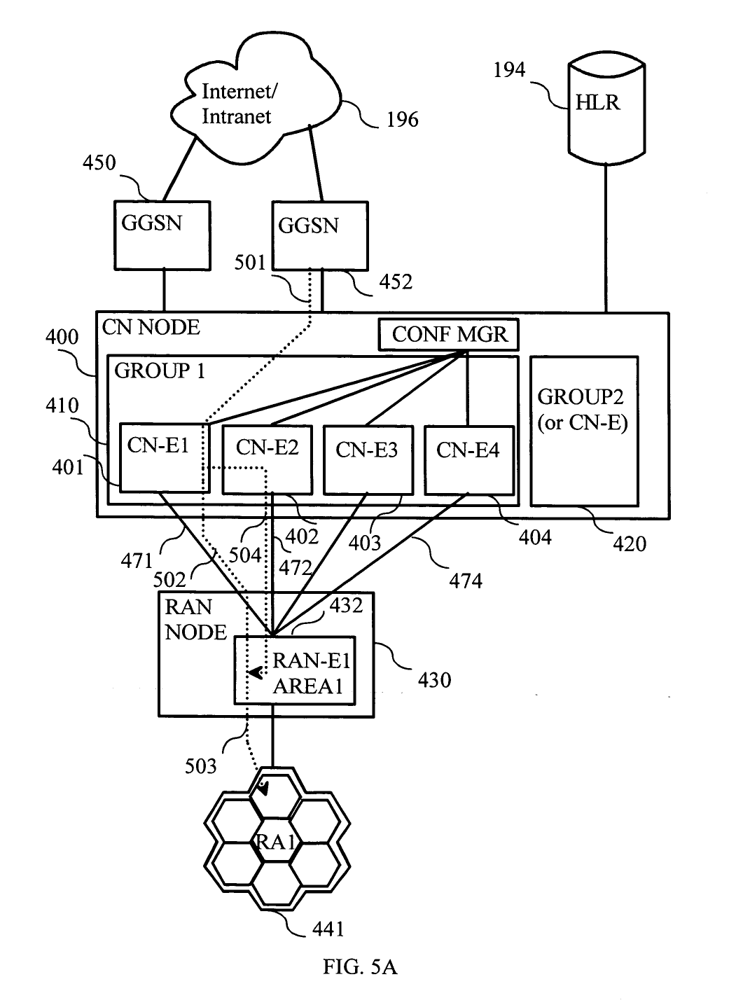

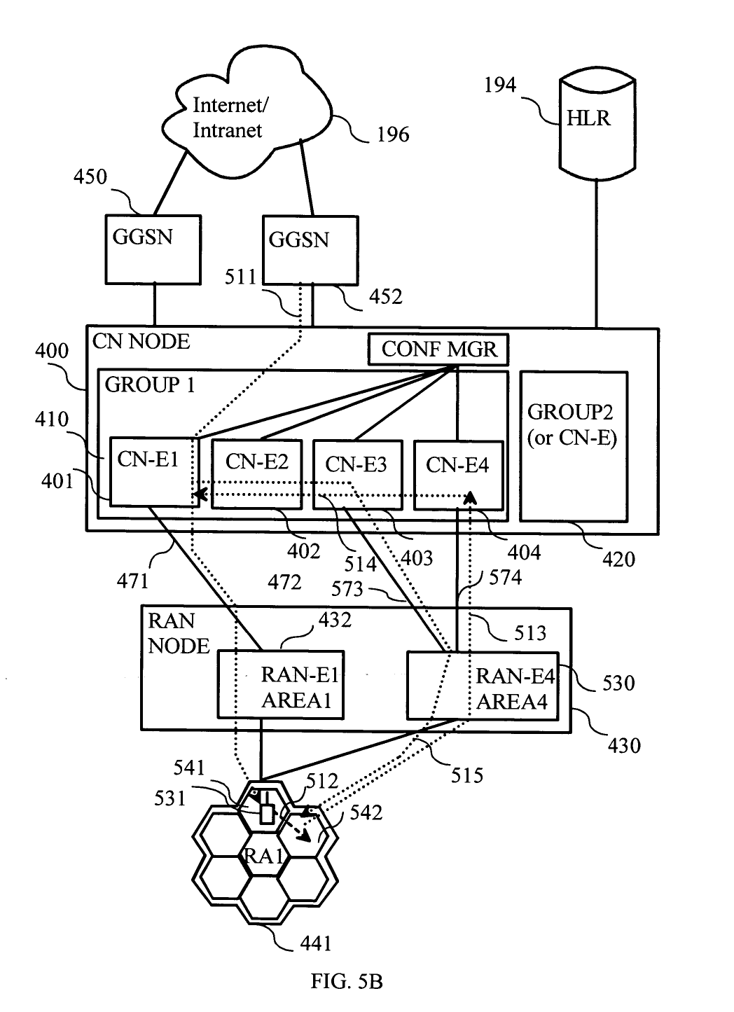

FIG. 5A is a block diagram illustrating a CN node with an unavailable connection in one embodiment of the invention. The CN node is a Serving GPRS Support Node (SGSN). In FIG. 5A there are CN entities 401-404, which are connected to a RAN entity 432 using connections 471-474. There is also illustrated a packet stream 501, which represents downlink packets sent from a GGSN 452. The downlink packets originate from an IP network 196. From CN entity 401 the downlink packets are sent to RAN entity 432 as a packet stream 502. From RAN entity 432 the downlink packets are sent towards a mobile station (not shown) as packet stream 503 within routing area 441. When there is a failure in connection 471 or connection 471 is locked due to operator action, the connection 471 becomes unavailable for the use of packet stream 502. As the failure is detected, CN entity 401 determines based on configuration information that CN entity 402 has connection 472 connected to RAN entity 432. Thereupon, CN entity 401 starts forwarding the downlink packets associated with packet stream 501 via CN entity 402. The downlink packets are sent from CN entity 402 as packet stream 504. In one embodiment of the invention CN entities 401-404 have a memory buffer, which is used to store the downlink packets not yet acknowledged by RAN entity 432. If there is a failure in a connection leading to RAN entity 432, the unacknowledged packets are resent via an alternative CN entity, which has a connection to RAN entity 432. In one embodiment of the invention a forwarding state indicator is stored in CN entity 401 associated with the mobile station. Before forwarding every new downlink packet, it is checked whether it is possible to stop forwarding the downlink packets via the drift CN entity. This is possible in cases where the connection from the original CN entity has re-entered active state.

FIG. 5B is a block diagram illustrating CN entity update processing a CN node in one embodiment of the invention. In FIG. 5B there is a mobile station 531 camping in a cell 541. There is also a neighboring cell 542. In a RAN node 430 there are RAN entities 432 and 530. RAN entity 432 is connected to a CN entity 401 using a connection 471, whereas RAN entity 530 is connected to CN entities 403 and 404 using connections 573 and 574, respectively. There is a downlink packet stream 511, which is sent to mobile station 531 via CN entity 401, RAN entity 432 and a base station for cell 541 (not shown). As illustrated with arrow 512, mobile station 531 switches from cell 541 to cell 542. Thereupon, mobile station 531 starts making a cell update towards CN node 400. As illustrated with arrow 513 a cell update message is sent to RAN entity 530 from RAN entity 530 to CN entity 404 via connection 574. RAN entity 530 chooses CN entity 404 arbitrarily or because it may have been configured in advance as the preferred contact point for requests originating from RAN entity 530. CN entity 404 determines from an identifier carried in the cell update message that CN entity 401 is currently assigned for traffic originating from mobile station 531. CN entity 404 forwards the cell update message to CN entity 401.

When receiving the cell update message CN entity 401 chooses a drift CN entity where the downlink traffic will be forwarded while mobile station is camping in a cell 542. CN entity 401 chooses the drift CN entity for mobile station 531 based on configuration information. The configuration information has earlier been made available for CN entity 401 through the distribution of configuration information from other CN entities. The configuration information is used by CN entity 401 to form a table of possible candidate CN entities that have an connection configured to RAN entity 530 via which cell 542 may be accessed. In this case the candidate CN entities are CN entity 403 and CN entity 404. The drift CN entity is chosen from the table using round robin method. Weighted Fair Queuing (WFQ) scheduling and flow control is normally performed according to general rules. When CN entity 403 has been chosen as the drift CN entity, CN entity 401 starts forwarding downlink packets to CN entity 403. All packets stored at the Network Service (NS) level are forwarded to CN entity 403. Similarly, subsequent new packets received to CN entity 401 from a GGSN pertaining to packet stream 511 are sent via CN entity 403 to RAN entity 530 and from RAN entity 530 to mobile station 531, as illustrated with arrow 515. It should be noted that similar cell update processing, drift CN entity selection and packet forwarding is applied in case a mobile station makes a cell update between two cells belonging to different RAN areas and different RAN areas are under the control of different CN entities. This situation occurs in the model disclosed in association with FIG. 4C.

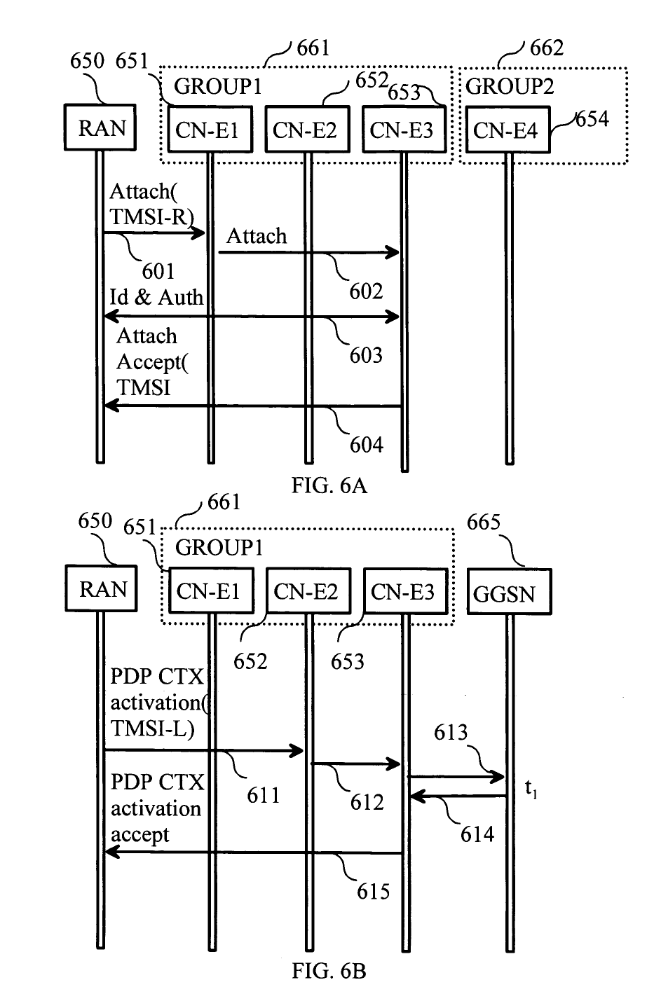

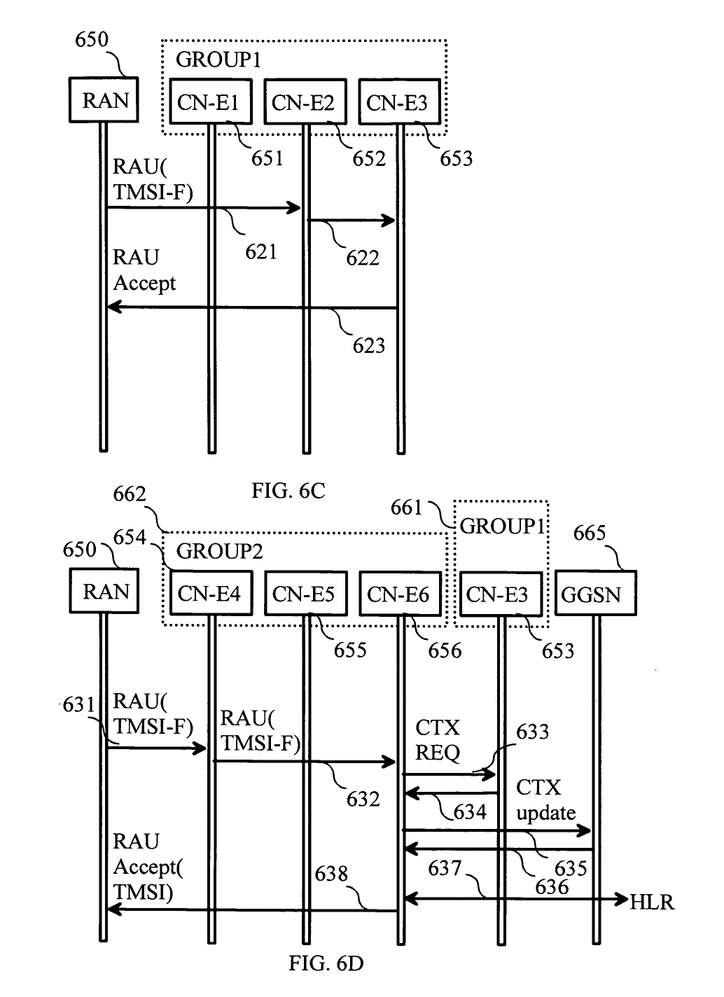

FIG. 6A is a signaling diagram, which illustrates network attach processing in one embodiment of the invention. In FIG. 6A there is a RAN 650 and a CN entity group 661 comprising CN entities 651-653. There is also another CN entity group 662 comprising at least CN entity 654. A network attach message is received from RAN 650 to CN entity 652 as illustrated with arrow 601. The network attach message originates from a mobile station (not shown). The network attach message comprises a Temporary Mobile Subscriber Identity (TMSI). In one embodiment of the invention, the network attach message is carried in a BSS GPRS Protocol (BSSGP) UL-UNITDATA PDU. In an UL-UNITDATA PDU there is a Temporary Logical Link Identity (TLLI), which is used as the TMSI in this embodiment. The BSSGP is specified in the specification GSM 08.18.

The fact that the Temporary Mobile Subscriber Identity (TMSI) is a random TMSI generated by the mobile station is indicated in FIG. 6A by denoting the random TMSI with TMSI-R. The TMSI type is local, foreign or random. Whether a TMSI is local, foreign or random depends on which address range a TMSI belongs. A local TMSI in a given CN entity is a TMSI that has been allocated by the same CN entity, a foreign TMSI has been allocated in a different routing area or location area and a random TMSI has been generated using random selection. When receiving the network attach message CN entity 651 determines whether the TMSI is local, foreign or random. If the TMSI is a random or foreign, CN entity 651 determines whether a CN entity index in the TMSI points to any CN entity in CN entity group 661. The determination is performed so that M bits of the random TMSI are extracted. The integer value expressed by the M bits is used as the TMSI index.

In one embodiment of the invention, the following structure may be used, for example, for TLLIs when the M is 5: 5 bits for use in accordance with 3GPP specification 23.003 (bits 31-27), 19 bits for a running counter (bits 26-8), 5 bits for CN entity index (bits 7-3 and 3 bits for a reset counter (bits 2-0).

If a CN entity index points outside CN entity group 661, the serving CN entity for the mobile station is selected by computing a hash code from the received TMSI. In one embodiment of the invention the hash code is computed by dividing the random TMSI by a number N and taking the remainder, wherein the number N represents the number of CN entities in the CN entity group 300. In other words, let I=(TMSI MOD N), wherein I represents the hash code i.e. the CN entity index and MOD represents the modulus operation. For example, in the case of FIG. 6A the computation for I yields 3, which indicates that CN entity 653 must become the serving CN entity for the mobile station. In other words, CN entity 653 is assigned for the mobile station. The network attach message is forwarded from CN entity 651 to CN entity 653 as illustrated with arrow 602. Thereupon, CN entity 653 serves the network attach normally. It identifies and authenticates the mobile station as illustrated with two-directional arrow 603. It obtains subscriber data for the mobile subscriber associated with the mobile station, if the CN node (not shown) comprising CN entity group 661 does not yet have the subscriber data associated with that subscriber. Thereupon, CN entity 653 assigns a local TMSI to the mobile station. The local TMSI comprises bits that carry the CN entity index for CN entity 653. In one embodiment of the invention, a local P-TMSI is used to form the local TLLI for the mobile station, which is used as the local TMSI. The mobile station uses the local TMSI subsequently when sending messages towards the CN node, which comprises CN entity group 661. Finally, CN entity 653 acknowledges the network attach to RAN 650 with an Attach Accept message as illustrated with arrow 604. In one embodiment of the invention, the Attach Accept message carries the local P-TMSI. The Attach Accept message is carried in a BSSGP DL-UNITDATA PDU.

In one embodiment of the invention, the solution as illustrated in FIG. 6A may be applied not just CN entities within a CN node, but between individual CN nodes so that, for example, the serving CN node is determined using the index extraction, the computation of the hash code and TMSI assignment as disclosed hereinbefore.

In one embodiment of the invention, the solution as illustrated in FIG. 6A may be applied to a location update procedure for location areas. In that case the CN entities will be MSCs or MSC servers and location update messages are used instead of the routing area update messages.

FIG. 6B is a signaling diagram, which illustrates Packet Data Protocol (PDP) Context activation in one embodiment of the invention. PDP context activation message is sent by a mobile station (not shown) via a RAN 650 to a CN node (not shown), which comprises a CN entity group 661. A CN entity 652 first receives the PDP context activation message illustrated with arrow 611, since RAN 650 may choose an arbitrary connection leading to the CN node, not just possible connections leading to a CN entity 653, which is the current serving CN entity for the mobile station. When receiving the PDP context activation message CN entity 652 masks the CN entity index from the received TMSI in an attempt to check whether the TMSI is random or local. In this case the TMSI is local and carries the CN entity index for CN entity 653. The PDP context activation message is forwarded from CN entity 652 to CN entity 653 as illustrated with arrow 612. CN entity 653 performs required checks and validates the request. If admission control allows, the PDP context is created. Thereupon, a Create PDP Context request message is sent by CN entity 653 to a GGSN 665 as illustrated with arrow 613. At time t₁, GGSN 665 creates a PDP context for the mobile station. The created PDP context will contain an address for CN entity 653, since on GGSN side CN entities are treated as individual SGSNs, in other words as individual CN nodes. GGSN 665 acknowledges the PDP context creation with Create PDP Context response message as illustrated with arrow 614. Thereupon, as illustrated with arrow 615 CN entity 653 sends PDP Context Action Accept message to RAN 650.

FIG. 6C is a signaling diagram, which illustrates intra CN entity group Routing Area Update (RAU) processing in one embodiment of the invention. A mobile station sends a Routing Area Update message via a RAN 650 to a CN node (not shown), which comprises a CN entity group 661. A CN entity 652 first receives the Routing Area Update message illustrated with arrow 621, since RAN 650 may choose an arbitrary connection leading to the CN node, not just possible connections leading to a CN entity 653, which is the current serving CN entity for the mobile station. When receiving the Routing Area Update message CN entity 652 checks whether the new routing area is within the CN entity group 661. In this case the new routing area is within the control of CN entity group 661. Therefore, CN entity 652 masks the CN entity index from the received TMSI in order to check that the TMSI is local. In this case the TMSI is local and carries the CN entity index for CN entity 653. The Routing Area Update message is forwarded from CN entity 652 to CN entity 653 as illustrated with arrow 622. Due to the fact that CN entity group does not change, it is not required to change the serving CN entity 653 and to update the currently active PDP contexts in the GGSNs. If a new TMSI was allocated, it is included in the response to RAN 650. CN entity 653 acknowledges the routing area update using Routing Area Accept message illustrated with arrow 623.

FIG. 6D is a signaling diagram, which illustrates inter CN entity group Routing Area Update (RAU) processing in one embodiment of the invention. A mobile station sends a Routing Area Update message (not shown) via a RAN 650 to a CN node (not shown), which comprises a CN entity group 662. A CN entity 654 first receives the Routing Area Update message illustrated with arrow 631. RAN 650 has earlier chosen a connection leading to a CN entity 654. When receiving the Routing Area Update message, CN entity 654 detects that old routing area is outside its CN entity group, namely a CN entity group 662. In one embodiment of the invention, CN entity 654 masks the CN entity index from the received TMSI in order to check whether the CN entity index points to a CN entity in CN entity group 662. If CN entity identifier points to a CN entity in CN entity group 662, the CN entity pointed to by the index is assigned as the serving CN entity for the mobile station, else a hash code providing the CN entity index is computed from the TMSI in a manner disclosed hereinbefore. As the CN entity index is determined, CN entity 654 forwards the Routing Area Update message to the serving CN entity as illustrated with arrow 632. In FIG. 6D the new serving CN entity is a CN entity 656. CN entity 656 sends an SGSN Context Request message to CN entity 653 within CN entity group 661 as illustrated with arrow 633. The correct old CN entity group is determined based on information provided in the Routing Area Update request message such as old routing area identifier. The actual old serving CN entity, namely CN entity 653, is determined based on the computation of the hash code from the foreign TMSI. In one embodiment of the invention, CN entity 656 sends the SGSN Context Request message to an arbitrary CN entity in CN entity group 661, which in turn determines the correct old serving CN entity. CN entity 653 responds by sending an SGSN Context Response message to CN entity 656 as illustrated with arrow 634. Thereupon, CN entity 656 updates the location in HLR and updates the PDP context in GGSN 665 as illustrated with arrows 635-637. If a new TMSI is allocated it is included in the Routing Area Update message sent from CN entity 656 to RAN 650, as illustrated with arrow 638.

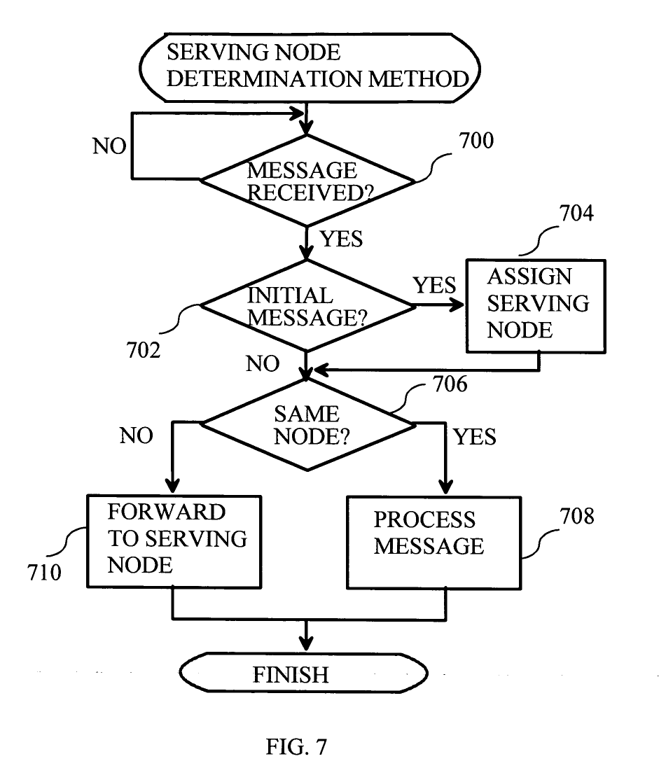

FIG. 7 is a flow chart depicting one embodiment of node determination method. The method may be applied, for example, in a communication network such as disclosed in association with the description of FIG. 3. At step 700 a node within a serving node cluster awaits a message from an access network. When the message is received, method continues at step 702 where it is checked by the node whether the message is an initial message received from a client node. The determination whether the message is an initial message may be performed, for example, with an indicator carried in the message. If the message is an initial message, at step 704 a serving node is assigned for the client node. If the message was not an initial message, it comprises at least one identifier, which is used to determine the serving node earlier assigned. At step 706 the node determines if the serving node is the same as the node currently processing the message. If the nodes are the same, at step 708 the message is processed accordingly in the node. If the nodes are not the same, at step 710 the node forwards the message to the correct serving node. In one embodiment of the invention, the node is a CN entity, the serving node cluster is a CN entity group, and the at least one identifier is a TMSI.

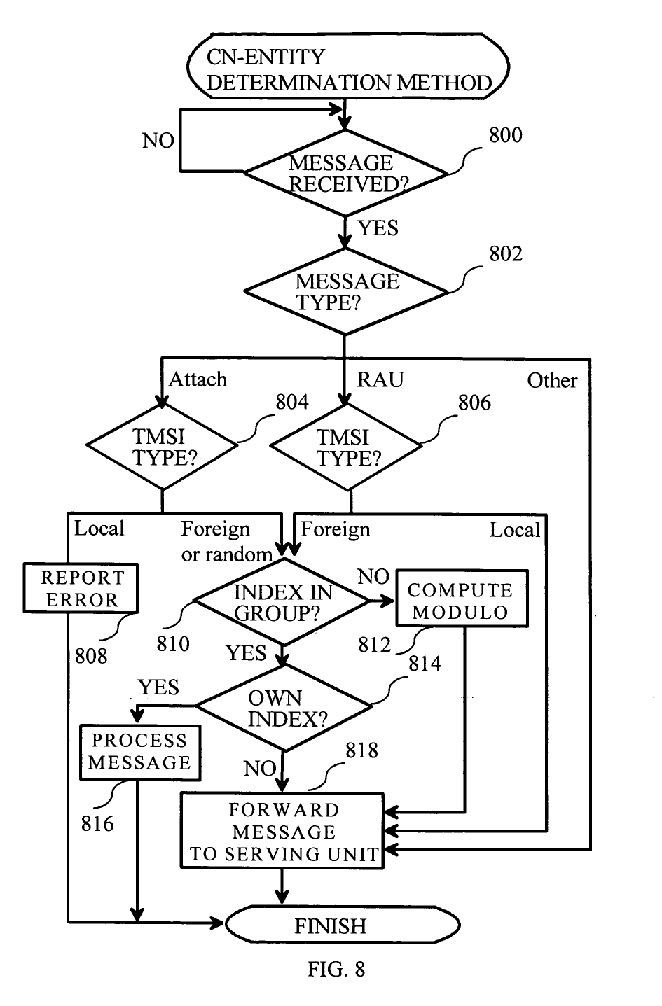

FIG. 8 is a flow chart depicting one embodiment of CN entity determination method in a distributed architecture CN node. At step 800 a CN entity, which is for example, a Packet Processing Unit (PAPU) such as disclosed in association with FIG. 1, waits for an initial message from the RAN. In one embodiment of the invention, the initial message is a Logical Link Control (LLC) layer PDU. The PDU carries a message originating from a mobile station. At step 802 the CN entity checks the type of the message. In one embodiment of the invention, the type of the message is checked from an LLC PDU. The message may be an attach message, in which case the method continues at step 804, a routing area update message, in which case the method continues at step 806, or another message such as an uplink user plane data packet, in which case the method continues at step 818.

At step 804 the TMSI type is checked. The TMSI type is local, foreign or random. Whether a TMSI is local, foreign or random depends on, for example, which address range a TMSI belongs. The CN entity analyzes the TMSI based on, for example, its knowledge pertaining to the TMSI address ranges in order to determine the TMSI type. In one embodiment of the invention, the TMSI comprises a field, which identifies the TMSI type. If the TMSI type is local an error is reported at step 808. If the TMSI type is foreign or random, the method continues at step 810.

At step 806 the TMSI type is checked in a manner similar to step 804. If the TMSI type is local method continues at step 818. If the TMSI type is foreign or random, the method continues at step 810.

At step 810 packet unit masks a packet unit index from the received TMSI in an attempt to check whether the CN entity index in the TMSI points to a CN entity in the same CN entity group. This is performed so that M bits of the TMSI are extracted. The integer value expressed by the M bits is used as the CN entity index. Thereupon, CN entity determines whether the CN entity index points to a CN entity within the same CN entity group as the CN entity. If the CN entity index points outside the CN entity group, the method continues at step 812, else method continues at step 814. At step 812 a hash code is computed of the TMSI. In one embodiment of the invention the hash code is computed by dividing the TMSI by a number N and taking the remainder, wherein the number N represents the number of CN entities in the CN entity group. In other words, let I=(TMSI MOD N), wherein I represents the hash code i.e. the packet CN entity index and MOD represents the modulus operation. The CN entity index points to the serving CN entity assigned.

At step 814 CN entity checks if the CN entity index points to it. If the CN entity index does not point to the CN entity, the method continues at step 818, else it continues at step 816. At step 816 the message is processed in CN entity itself. At step 818 the CN entity forwards the message to the serving CN entity assigned either at step 814 or determined at step 814 based on extracting the CN entity index from a local TMSI. In one embodiment of the invention, the packet unit may also be a separate SGSN. In one embodiment of the invention, the TMSI is a TLLI.

In one embodiment of the invention, at step 814 the serving CN entity is not simply determined by computing a modulus from the TMSI. When CN entities are grouped together the load is not probably divided equally between different CN entities in the CN entity group. In this embodiment of the invention, there is a mechanism, which is used when a new mobile station is entering in the area controlled by the CN entity group. The mobile station is assigned for handling to the least loaded CN entity. Load balancing is performed using a round robin method or using statistical information providing the load levels in different CN entity of the group. Also more enhanced load-balancing functions could take place, for example, new resource manager or admission control functionalities may be used. Resource management functionality will collect the load information from all CN entities. The resource manager consists of two parts: a load information collector entity, which is provided in each CN entity, and a centralized resource manager entity, which is provided in centralized place that may control all CN entities. Each CN entity locally collects the load information. Load information consists, for example, of the number of attached subscribers and both downlink and uplink data throughput, per each CN entity. The load information collector entity sends the pre-processed load information values to the centralized resource manager entity. The centralized resource manager entity calculates total CN entity load per each CN entity. The resource manager provides the CN entity load values to the admission control function.

Admission control functionality determines a CN entity within the CN entity group that will serve a certain mobile station. The admission control will provide a preferred CN entity, which has the lowest load for every CN entity in the group. The admission control function consists of two parts: a local admission controller entity, which is provided in each CN entity and a centralized admission manager entity in a separate unit. The local admission controller decides the serving CN entity based on the currently preferred CN entity, provided by the admission manager. The local admission controller updates its preferred CN entity, for example, at every tenth new admission request by requesting updated value from admission manager.

In one embodiment of the invention, the determining of the serving CN entity comprises also the forming of a candidate serving CN entity list from the CN entities in the group based on the configuration information, the computation of a hash code from the TMSI, and selecting the second serving CN entity from the candidate serving CN entity list by indexing with the hash code. The hash code is computed, for example, by dividing said TMSI by the number of candidate unit in the candidate serving CN entity list and taking the remainder. The configuration information is used, for example, in order to determine whether a connection, for example, an NS-VC is configured to the cell, RAN area or routing area in which the mobile station is currently located. The configuration information may also be checked in order to determine the status of the connections from each CN entity in the CN entity group. If connections from a CN entity are not active or configured to the current area of the mobile station, the CN entity is not included in the candidate serving unit list.

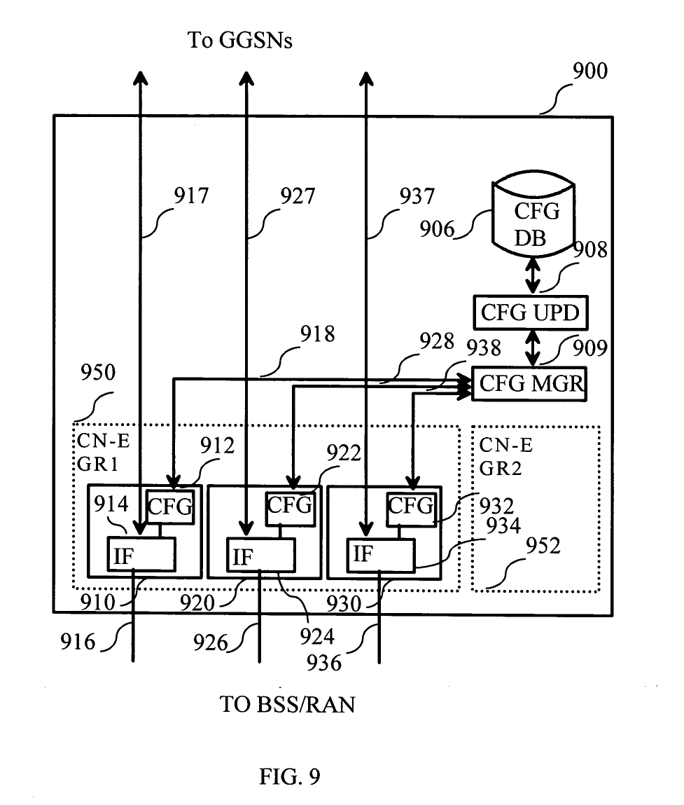

FIG. 9 is a block diagram illustrating software and hardware architecture in a distributed architecture Serving GPRS Support Node (SGSN), in one embodiment of the invention. In FIG. 9 there is an SGSN 900, which comprises PAPU groups 950 and 952. PAPU group 950 consists of PAPUs 910, 920 and 930. In this embodiment of the invention, a group is treated as a CN entity group and a PAPU as a CN entity. PAPUs 910, 920 and 930 comprise interface entities 914, 924 and 934, respectively. PAPUs 910, 920 and 930 also comprise configuration entities 912, 922 and 932, respectively. Interface entities 910, 920 and 930 have connections 916, 926 and 936 towards a BSS or generally a RAN. In one embodiment of the invention, the connections are NS-VCs. In another embodiment of the invention, the connections are, for example, Asynchronous Transfer Mode (ATM) virtual circuits. In one embodiment of the invention, configuration entities 912, 922 and 932 interface a configuration manager entity 909. The configuration manager entity is configured to receive configuration update information from configuration entities 912, 922 and 932. The configuration manager entity is configured to distribute configuration information to configuration entities 912, 922 and 932 whenever there is a change in the configuration information, which must be informed to at least one of the PAPUs 910, 920 and 930. The configuration manager interfaces a configuration update entity 908, which accesses configuration data in a configuration database 906.

In one embodiment of the invention, the configuration entities 912, 922 and 932 provide the load information collector entities and configuration manager entity 909 provides the centralized resource manager entity disclosed in association with FIG. 8. In one embodiment of the invention, the configuration entities 912, 922 and 932 provide the local admission controller entities and configuration manager entity 909 provides the centralized admission manager entity disclosed in association with FIG. 8.

All configuration-related static and dynamic information needs to be available in each PAPU serving the same radio network area, for example, a routing area or a location area. Static information does not change without operator-originated modification, for example, pertaining to NSVC configurations between network service entities. Dynamic configuration information changes without any user actions, for example, when a BVC reset is received from a BSC. The information sharing operations can be handled with a variety of methods.

In one embodiment of the invention, configuration manager 909 is used. It performs centralized group management functions and stores group related configuration information using a configuration update entity 908. When information changes, configuration manager is updated and it distributes changed information to all PAPUs within the group affected by the change. In one embodiment of the invention multicasting is used to share all relevant information with other grouped PAPUs. In one embodiment of the invention, a both multicasting and configuration manager 909 are used. Direct multicast is used for time-critical messages, for example, relating to BVC flow control. Configuration manager is used for other messages. Mobile station flow control is forwarded to the PAPU that serves the mobile station. PAPU is addressed using PAPU index encoded to the TLLI. The use of mobile station flow control is very simple: mobile station flow control is performed individually in the PAPU, which serves the mobile station.

In the case where a BSC supports also cell specific flow control, that is, BVC flow control, flow control mechanisms must be present in the SGSN end as well. In the model disclosed in association with FIG. 4A, which distributes cells or RAN areas to multiple CN entities, also BVC flow control needs to be distributed as well. It should be noted that if BSC is able to work with MS flow control only it could, however, be configured to advertise BVC flow control maximum value. This is necessary since, according to standards, BVC flow control is required at least once after the creation of a cell. This mechanism would help the CN entities in BVC flow control sharing, since BVC flow control would not be a bottleneck anymore.

In models disclosed in association with FIGS. 4B and 4C predefined cells or RAN areas are handled by one CN entity, therefore all downlink data to the specific RAN area or cell needs to be forwarded through the specific CN entity, and BVC flow control is not a problem. In all models where several CN entities handle same cells BVC flow control parameters, for example, bucket size and leak rate are communicated between the CN entities in the CN entity group. The actual mechanism for flow control sharing is operator configurable. In models of FIGS. 4B and 4C the BVC flow control is not shared and it does not need adjustment, since the BVC flow control is performed in a single CN entity. In the model of FIG. 4A BVC flow control may be adjusted. Leak rate and bucket size, in other words, all BVC flow control parameters are adjustable using BVC flow control capacity adjuster, which is configured by operator actions. The BVC flow control capacity adjuster may have values from 1 to N, wherein N equals the number of CN entities in the CN entity group. Bucket size is unmodified and is shared by each CN entity in the CN entity group by default. Bucket size is shared in order to assure that the cell buffering capacity in BSS is not exceeded.

In the BVC flow control each node is assigned an Allocated BVC Flow Control Capacity (ABFCC), which is the result of the calculation and the value used in actual BVC flow control. A BSS Provided BVC Flow Control Capacity (BPBFCC) is the original value provided by the BSS. Bucket size in the ABFCC equals BPBFCC divided by the number of CN entities in CN entity group. Leak rate in ABFCC cannot be bigger that leak rate in BPBFCC. The TBFCC is the sum of unmodified ABFCCs for each CN entity. The TBFCC is equal to the BPBFCC. Default portion for both leak rate and bucket size in the ABFCC is determined based on circuit rate values for RAN areas in each CN entity. All circuit rates are summed and given a percentage value. Each CN entity is given equal share of the BPBFCC of what the percentage value determines. By default allocated BVC flow control capacity (ABFCC) in each CN entity is between 0-100% and a total BVC flow control capacity (TBFCC) never exceeds 100% of the BPBFCC. When the CN entity group size is rather big, for example 4 CN entities, operator may like to over-dimension the leak rate to maximize data throughput. Leak rate parameter should not, however, be increased too much to avoid buffer overflow in the BSS. If cells are small serving only few GPRS subscribers at the time over-dimension can be higher, but in case of larger cells over-dimension should be restrained.

In one embodiment of the invention, BVC flow control is distributed dynamically. This means that in case in a CN entity there are no mobile stations or active PDP contexts in the area of a given cell, the CN entity informs this fact to the configuration manager entity or other CN entities sharing the same RAN area to which the cell belongs. The other CN entities will increment their own ABFCC values correspondingly. The increment is obtained, for example, by dividing the portion of BVC capacity per one CN entity by the number of other CN entities.

In one embodiment of the invention, each CN entity monitors the number of received Logical Link Control (LLC) discard messages and based on the number, determines if BPBFC should be decreased.

It is obvious to a person skilled in the art that with the advancement of technology, the basic idea of the invention may be implemented in various ways. The invention and its embodiments are thus not limited to the examples described above; instead they may vary within the scope of the claims.

1. A method for controlling data communication in a communication network comprising at least two serving nodes, the method comprising:
forming a group comprising at least two serving nodes in said communication network;
associating at least one terminal node with said group;
receiving configuration information in a first serving node from a second serving node;
receiving a first message from a terminal node in said first serving node;
determining, in said first serving node, said second serving node from said group with at least a first identifier in said first message and said configuration information;
sending said first message from said first serving node to said second serving node;
processing said first message in said second serving node;
providing a second identifier indicating said second serving node to said terminal node; and
indicating said second serving node in a second message from said terminal node.

2. The method according to claim 1, further comprising:
collecting load information associated with at least one serving node within said group; and
checking said load information in said determining said second serving node.

3. The method according to claim 1, further comprising using said communication network as a mobile network and using said terminal node as a mobile node.

4. The method according to claim 3, further comprising using said first and said second identifier as a Temporary Mobile Subscriber Identity (TMSI).

5. The method according to claim 4, further comprising using said first identifier as a Temporary Logical Link Identity (TLLI) and using said second identifier as a Packet Temporary Mobile Subscriber Identity (P-TMSI).

6. The method according to claim 3, further comprising using said mobile network as a General Packet Radio System (GPRS) network.

7. The method according to claim 6, further comprising using at least one of the first serving node or the second serving node as a computer unit in a Serving GPRS Support Node (SGSN).

8. The method according to claim 7, further comprising addressing computer units in at least one Gateway GPRS Support Node (GGSN) as separate Serving GPRS Support Nodes (SGSN).

9. The method according to claim 3, further comprising using said mobile network as a Universal Mobile Telecommunications (UMTS) network.

10. The method according to claim 3, further comprising using at least one of the first serving node or the second serving node as at least one of a Mobile services Switching Center (MSC) or a mobile services switching center server.

11. The method according to claim 3, further comprising using at least one of the first serving node or the second serving node as at least one of a computer unit in a Mobile services Switching Center (MSC) or a mobile services switching center server.

12. The method according to claim 1, further comprising using said communication network as an IP network.

13. The method according to claim 1, wherein said communication network comprises at least a circuit switched network.

14. The method according to claim 1, further comprising using said first message as a network attach message.

15. The method according to claim 1, further comprising using said second message as an uplink packet from said terminal node.

16. The method according to claim 1, further comprising using said second message as a call set-up request message.

17. The method according to claim 1, further comprising using said second message as a location update request message.

18. The method according to claim 1, wherein said determining step further comprises:
forming a candidate serving node list based on said configuration information;
computing a hash code from said first identifier; and
selecting said second serving node from said candidate serving node list by indexing said candidate serving node list with said hash code.

19. The method according to claim 18, further comprising computing said hash code by dividing said first identifier by the number of candidate nodes in the candidate serving node list and taking the remainder.

20. A communication system comprising:
at least one terminal node; and
a serving node group comprising at least a first serving node and a second serving node,
wherein said first serving node is configured to receive configuration information from said second serving node, to receive a first message from a terminal node, to select said second serving node from said group with at least a first identifier in said first message and said configuration information, and to send said first message to said second serving node,
wherein said second serving node is configured to process said first message and to provide an second identifier indicating said second serving node to said terminal node, and
wherein said terminal node is configured to indicate said second serving node in a second message.

21. The communication system according to claim 20, wherein said first serving node is further configured to:
provide load information, and
wherein said second serving node is further configured to check said load information during selection of said a second serving node.

22. The communication system according to claim 20, wherein said communication network is a mobile network and said terminal node is a mobile node.

23. The communication system according to claim 22, wherein said first and said second identifier is a Temporary Mobile Subscriber Identity (TMSI).

24. The communication system according to claim 23, wherein said first identifier is a Temporary Logical Link Identity (TLLI) and said second identifier is a Packet Temporary Mobile Subscriber Identity (P-TMSI).

25. The communication system according to claim 20, wherein said mobile network is a General Packet Radio System (GPRS) network.

26. The communication system according to claim 25, wherein at least one of the first serving node or the second serving node is a computer unit in a Serving GPRS Support Node (SGSN).

27. The communication system according to claim 26, wherein computer units are addressed in at least one Gateway GPRS Support Node (GGSN) as separate Serving GPRS Support Nodes (SGSN).

28. The communication system according to claim 22, wherein said mobile network is a Universal Mobile Telecommunications (UMTS) network.

29. The communication system according to claim 22, wherein at least one of the first serving node or the second serving node is at least one of a Mobile services Switching Center (MSC) or a mobile services switching center server.

30. The communication system according to claim 22, wherein at least one of the first serving node or the second node is a computer unit in a Mobile services Switching Center (MSC) or a mobile services switching center server.

31. The communication system according to claim 20, wherein said communication network is an IP network.

32. The communication system according to claim 20, wherein said communication network comprises at least a circuit switched network.

33. The communication system according to claim 20, wherein said first message is a network attach message.

34. The communication system according to claim 20, wherein said second message is an uplink packet from said terminal node.

35. The communication system according to claim 20, wherein said second message is a call set-up request message.

36. The communication system according to claim 20, wherein said second message is a location update request message.

37. The communication system according to claim 20, wherein said first serving node is further configured to:
form a candidate serving node list based on said configuration information;
compute a hash code from said first identifier; and
select said second serving node from said candidate serving node list by indexing said candidate serving node with said hash code.

38. The communication system according to claim 37, wherein first serving node is configured to compute said hash code by dividing said first identifier by the number of candidate nodes in the candidate serving node list and taking the remainder.

39. A network node for serving at least one terminal node comprising:
a configuration entity configured to receive configuration information from a second network node, and to provide said configuration information to an interface entity;
wherein said interface entity is configured to receive a first message from a terminal node, to select said second network node with at least a first identifier in said first message and said configuration information, to send said first message to said second network node, to process said first message, and to provide an second identifier indicating said second network node to said terminal node.

40. A computer program comprising code adapted to perform the following steps when executed on a data-processing system:
forming a group comprising at least two serving nodes in a communication network;
associating at least one terminal node with said group;
receiving configuration information in a first serving node from a second serving node;
receiving a first message from a terminal node in said first serving node;
determining, in said first serving node, said second serving node from said group with at least a first identifier in said first message and said configuration information;
sending said first message from said first serving node to said second serving node;
processing said first message in said second serving node;
providing an second identifier indicating said second serving node to said terminal node; and
indicating said second serving node in a second message from said terminal node.

41. The computer program according to claim 40, wherein said computer program is stored on a computer readable medium.

42. The computer program according to claim 41, wherein said computer readable medium is a removable memory card.

43. The computer program according to claim 41, wherein said computer readable medium is a magnetic or an optical disk.
